(19) United States
(12) Patent Application Publication
(10) Pub. No.: US 2014/0236418 A1
(43) Pub. Date: Aug. 21, 2014

(54) SHOVEL, SHOVEL MANAGEMENT DEVICE, AND SHOVEL MANAGEMENT METHOD

(71) Applicant: SUMITOMO HEAVY INDUSTRIES, LTD., Tokyo (JP)

(72) Inventors: Masato Koga, Yokosuka-shi (JP); Yukihiro Nakama, Yokosuka-shi (JP)

(21) Appl. No.: 14/347,728

(22) PCT Filed: Sep. 24, 2012
(86) PCT No.: PCT/JP2012/074338

§ 371 Date: Mar. 27, 2014

(30) Foreign Application Priority Data
Sep. 30, 2011 (JP) 2011-216575
Oct. 25, 2011 (JP) 2011-233772

(51) Int. Cl. G05B 23/02

(52) U.S. Cl. CPC G05B 23/0272; G05B 23/0283
USPC 701/31.6

(57) ABSTRACT

A machine controller controls a display device. The machine controller displays a suspected component which is estimated to be defective on the display device such that priority associated with the suspected component can be recognized, on the basis of failure estimation information including the suspected component and the priority associated with the suspected component.

### TECHNICAL FIELD

The present invention relates to a shovel, a shovel management device, and a shovel management method.

### BACKGROUND ART

In a defect management system according to the related art, when a certain failure occurs in a working machine, a measure example suitable to repair the failure is searched from a defect management information table on the basis of the model, type, machine number, and failure code of the working machine. An item “priority” is set in the defect management information table. For example, priority is set such that higher priority is given to a larger number of past failure measure examples. A service man repairs the failure with reference to the defect management information table.

In addition, in an abnormality analysis system, the cause of a failure and the state value of a machine when the failure occurs are stored as training data in a database. When a certain abnormality occurs in a machine, abnormality factor identification information indicating whether the abnormality is caused by an abnormal operation, abnormal traveling, or the deterioration of a component is extracted from various kinds of machine information. The training data is selected on the basis of the abnormality factor identification information. A process of deciding the cause of the abnormality is performed by a data mining method on the basis of the selected training data.

A working machine failure diagnosis device has been known which determines the type of failure on the basis of signals acquired by various sensors and displays a failure code and the content of the failure. The failure diagnosis device displays the content of the failure that the values detected by the sensors are abnormal, but does not provide information indicating a defective component and trouble shooting.

In addition, a working machine failure diagnosis device has been known which determines whether a failure occurs in a sensor and displays the content of the failure, such as the short circuit or grounding of a signal line as a symbol image corresponding to the content of the failure.

### PRIOR ART DOCUMENTS

### Patent Literature

PTL 1: International Publication No. WO 2006/085469
PTL 2: Japanese Unexamined Patent Application Publication No. 2010-55545
PTL 3: Japanese Unexamined Patent Application Publication No. 2007-224531
PTL 4: Japanese Unexamined Patent Application Publication No. 2010-180636

### SUMMARY OF INVENTION

### Problem to be Solved by Invention

It is difficult to decide a cause of abnormality on the basis of various kinds of information when the abnormality occurs. In addition, the defined cause of abnormality is not necessarily the real cause.

In the failure diagnosis device according to the related art, since a defective component is not specified, it is difficult to determine how to take trouble shooting on the basis of, for example, abnormal signals from the sensors.

### Solution to Problem

According to an aspect of the invention, there is provided a shovel including a display device and a machine controller that controls the display device. The machine controller displays a suspected component which is estimated to be defective on the display device such that priority associated with the suspected component can be recognized, on the basis of failure estimation information including the suspected component and the priority associated with the suspected component.

According to another aspect of the invention, there is provided a shovel management device including a display device and a processing device that controls the display device. The processing device displays a suspected component which is estimated to be defective in a shovel on the display device such that priority associated with the suspected component can be recognized, on the basis of failure estimation information including the suspected component and the priority associated with the suspected component.

According to still another aspect of the invention, there is provided a shovel management method including: acquiring, from a shovel to be diagnosed, measured values of a plurality of operating variables related to operation information about the shovel; calculating posterior probability of a failure type for specifying a failure which occurs in an evaluation target, which is a unit of evaluation, for each evaluation target, on the basis of causality information in which the measured values of the operating variables acquired from the shovel and the failure type are associated with each other, using an event in which the operating variables are the measured values acquired from the shovel to be diagnosed as a result; and giving priority to the failure type on the basis of the calculated posterior probability and outputting the failure type to an output device.

### Advantageous Effects of Invention

According to the invention, priority is associated with a suspected component and can be recognized. Therefore, even when a plurality of suspected components are displayed, it is possible to easily narrow down a defective portion.

### BRIEF DESCRIPTION OF DRAWINGS

FIG. 1 is a side view illustrating a working machine according to Embodiment 1.

FIG. 2 is a block diagram illustrating a driving system of the working machine according to Embodiment 1.

FIG. 3 is a block diagram illustrating an information system of the working machine according to Embodiment 1.

FIG. 4 is a diagram illustrating an example of a failure management table.

FIG. 5 is a diagram illustrating failure estimation information.

FIG. 6 shows the image of a machine body, basic information of the machine body, and operation buttons displayed on a display device.

FIGS. 7A and 7B show the images of a portion including a suspected component displayed on the display device.

FIG. 7C shows the image of the portion including the suspected component and failure information displayed on the display device.

FIG. 7D shows the image of check items displayed on the display device.

FIG. 7E shows the image of a maintenance process displayed on the display device.

FIG. 8 is a flowchart illustrating a process of creating causality information for failure diagnosis according to Embodiment 1 and storing the causality information.

FIG. 9 is a diagram illustrating an example of an operating variable and a failure type acquired from the shovel to be evaluated.

FIG. 10 is a histogram of an operating time for describing a method of discretizing the operating variable.

FIG. 11 is a diagram illustrating the relationship (causality information) between the discretized operating variable and the failure type.

FIG. 12 is a diagram illustrating an example of the prior probability and conditional probability of a failure estimation model used in Embodiment 1.

FIG. 13 is a flowchart illustrating a process of inferring the posterior probability of the failure type performed by a working machine management device according to Embodiment 1.

FIG. 14 is a diagram illustrating the discretized value of the operating variable acquired from the working machine to be diagnosed and the inferred posterior probability of the failure type.

FIG. 15 is a diagram illustrating an example of an operating variable and a failure type acquired from a shovel to be evaluated according to Embodiment 2.

FIG. 16 is a diagram illustrating an example of the prior probability and conditional probability of a failure estimation model used in Embodiment 2.

### DESCRIPTION OF EMBODIMENTS

### Embodiment 1

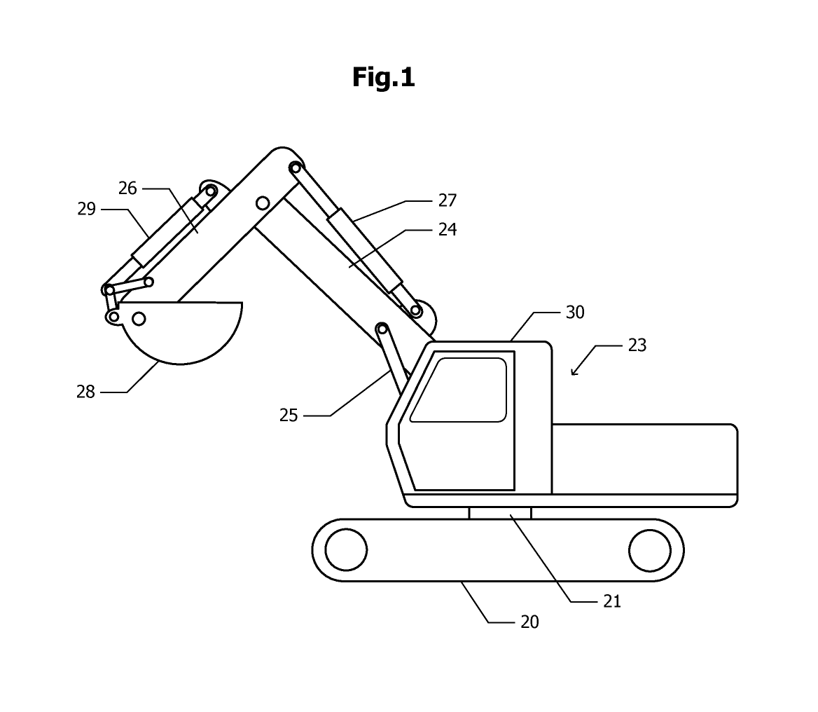

FIG. 1 is a side view illustrating a hydraulic shovel according to Embodiment 1. An upper rotating body 23 is mounted on a base carrier (base) 20 through a rotating mechanism 21. The rotating mechanism 21 includes an electric motor (motor) and rotates the upper rotating body 23 in a clockwise direction or a counterclockwise direction. A boom 24 is attached to the upper rotating body 23. The boom 24 is oscillated in the vertical direction relative to the upper rotating body 23 by a boom cylinder 25 which is hydraulically driven. An arm 26 is attached to the leading end of the boom 24. The arm 26 is oscillated in the front-rear direction relative to the boom 24 by an arm cylinder 27 which is hydraulically driven. A bucket 28 is attached to the leading end of the arm 26. The bucket 28 is oscillated in the vertical direction relative to the arm 26 by a bucket cylinder 29 which is hydraulically driven. In addition, a cabin 30 which accommodates an operator is mounted on the upper rotating body 23.

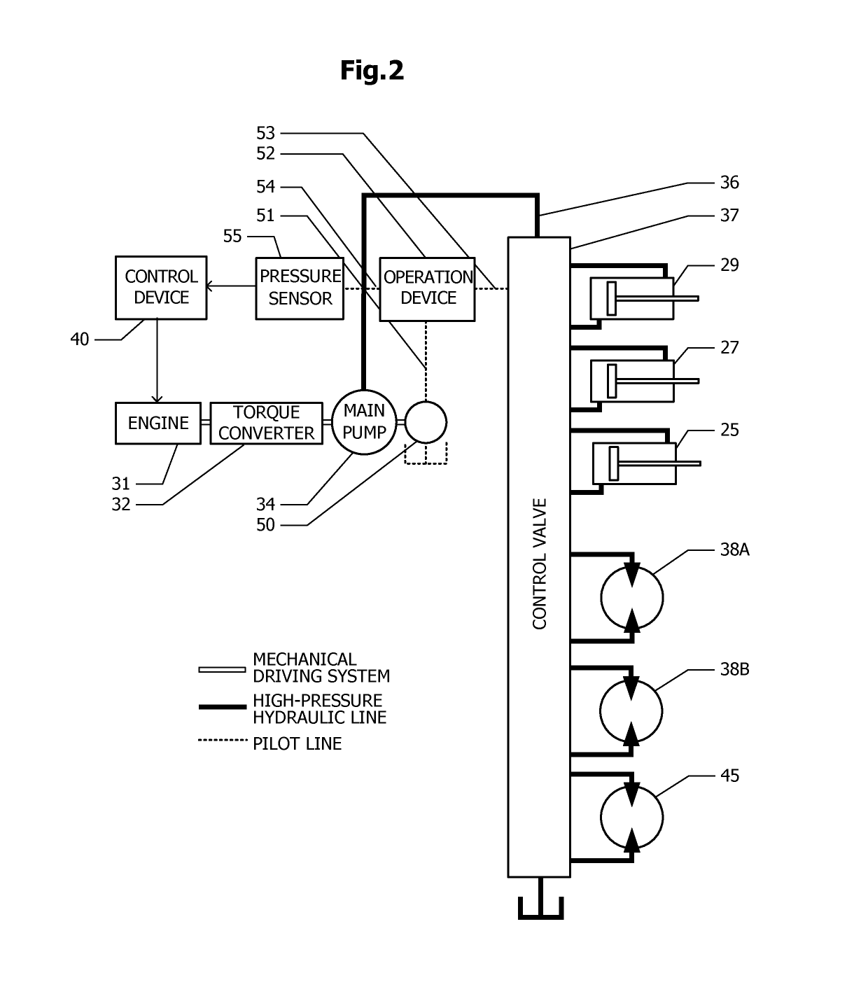

FIG. 2 is a block diagram illustrating a driving system and a hydraulic system of the shovel according to Embodiment 1. In FIG. 2, the driving system is represented by a double line, a high-pressure hydraulic line is represented by a thick solid line, and a pilot line is represented by a dashed line.

A drive shaft of an engine 31 is connected to a main pump 34 through a torque converter 32. An engine which generates driving force using fuel combustion, for example, an internal-combustion engine, such as a diesel engine, is used as the engine 31. The engine 31 is constantly driven while a working machine is operating. The main pump 34 is an external load of the engine 31.

The main pump 34 supplies hydraulic pressure to a control valve 37 through a high-pressure hydraulic line 36. The control valve 37 distributes the hydraulic pressure to traveling hydraulic motors 38A and 38B, a rotating hydraulic motor 45, the boom cylinder 25, the arm cylinder 27, and the bucket cylinder 29 in response to instructions from the operator. The traveling hydraulic motors 38A and 38B drive two left and right crawlers which are provided in the base carrier 20 shown in FIG. 1, respectively. The rotating hydraulic motor 45 drives the rotating mechanism 21 shown in FIG. 1.

A pilot pump 50 generates pilot pressure required for a hydraulic operation system. The generated pilot pressure is supplied to an operation device 52 through a pilot line 51. The operation device 52 includes a lever or a pedal and is operated by the operator. The operation device 52 converts primary hydraulic pressure supplied from the pilot line 51 into secondary hydraulic pressure in response to the operation of the operator. The secondary hydraulic pressure is transmitted to the control valve 37 through the hydraulic line 53 and is also transmitted to a pressure sensor 55 through another hydraulic line 54.

The detection result of pressure by the pressure sensor 55 is input to a control device 40. Therefore, the control device 40 can detect the operating state of the base carrier 20, the rotating mechanism 21, the boom 24, the arm 26, and the bucket 28. The control device 40 controls the output of the engine 31 on the basis of the operating state.

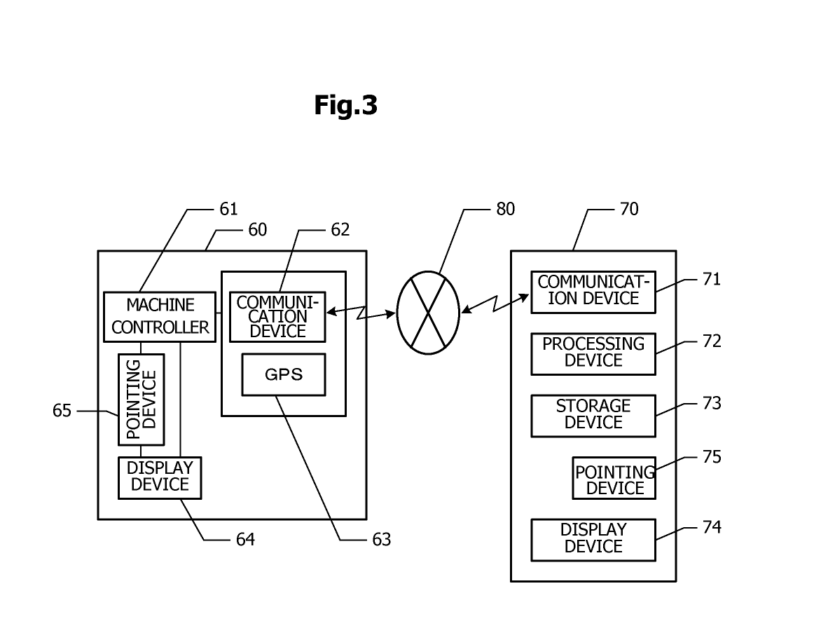

FIG. 3 is a block diagram illustrating an information system of the shovel according to Embodiment 1 and is a block diagram illustrating a management device (management center). A shovel 60 is provided with a machine controller 61, a communication device 62, an in-machine GPS device 63, a display device 64, and a pointing device 65. The machine controller 61 receives the measured values of operating variables which are measured by various sensors provided in the shovel 60. The shovel 60 corresponds to, for example, a shovel, which is a diagnosis target, or a shovel, which is an evaluation target for collecting causality information for failure diagnosis.

The pointing device 65 can designate coordinates on a screen of the display device 64. The designated coordinates are input to the machine controller 61. For example, a joystick, a touch pad, a touch panel, or a trackball can be used as the pointing device 65.

The communication device 62 transmits and receives various kinds of information to and from a management device 70 through a communication line 80. The in-machine GPS device 63 measures the current position of the shovel 60.

The management device 70 includes a communication device 71, a processing device 72, a storage device 73, a display device 74, and a pointing device 75. The communication device 71 transmits and receives various kinds of information to and from the shovel 60 through the communication line 80. The processing device 72 estimates the failure type which occurs or will occur in the shovel 60 on the basis of the measured values of the operating variables received from the shovel 60. In general, a plurality of failure types are estimated and priority is given to the failure types in descending order of occurrence probability. The process of estimating the failure type will be described in detail below.

The storage device 73 stores various kinds of information required for the processing device 72 to perform the estimation process. The display device 74 displays the estimation result of the failure type by the processing device 72. The estimation result is transmitted as failure estimation information to the shovel 60 through the communication device 71.

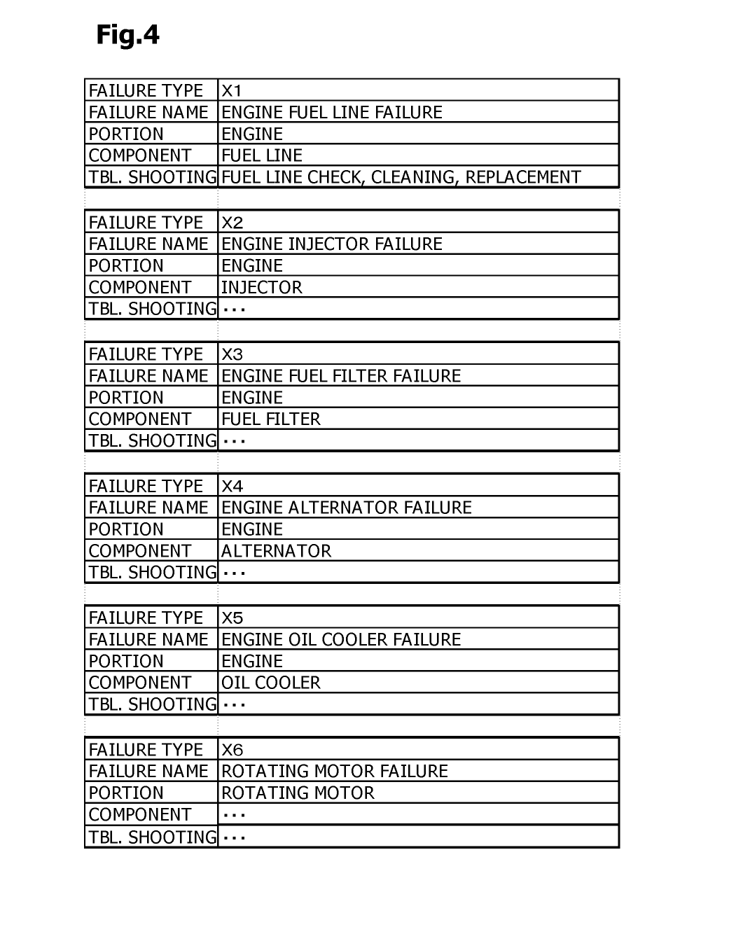

FIG. 4 shows an example of a failure management table. The failure management table is stored in the storage device 73 (FIG. 3) of the management device 70. The shovel 60 is partitioned into a plurality of portions each of which has a unitary function. Each of the portions includes a plurality of components. For example, a portion “engine” includes a plurality of components, for example, a fuel line, an injector, a fuel filter, an alternator, and an oil cooler.

The failure management table is prepared for each failure type. Each failure management table is identified by a failure type X and includes information about a failure name, a defective portion, a defective component, and trouble shooting. For example, the name of a failure whose failure type X is X1 is “engine fuel line failure”, the defective portion is the “engine”, the defective component is “fuel line”, and the trouble shooting is “fuel line check, cleaning, and replacement”.

The failure management table is prepared for the expected failure. When a failure which has not been expected occurs, a failure management table is newly made for the failure. FIG. 4 shows failure management tables for six failure types. However, in practice, failure management tables that include more than six failure types are prepared.

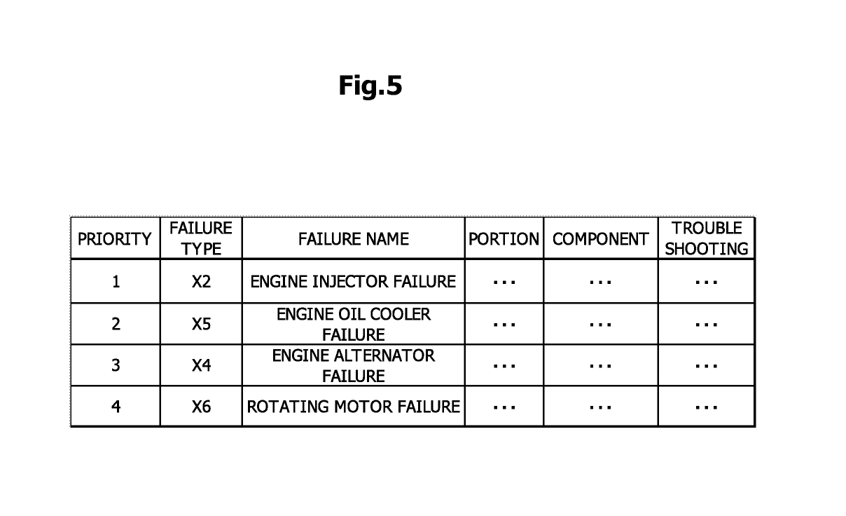

FIG. 5 shows an example of the failure estimation information which is transmitted from the management device 70 (FIG. 3) to the shovel 60. The failure estimation information includes priority, a failure type, a failure name, a portion, a component, and trouble shooting. The component which is estimated to be defective is referred to as a “suspected component”. For example, failure types with priority 1 to priority 4 are transmitted to the shovel 60. The machine controller 61 of the shovel 60 displays failure information as an image on the display device 64 on the basis of the failure estimation information.

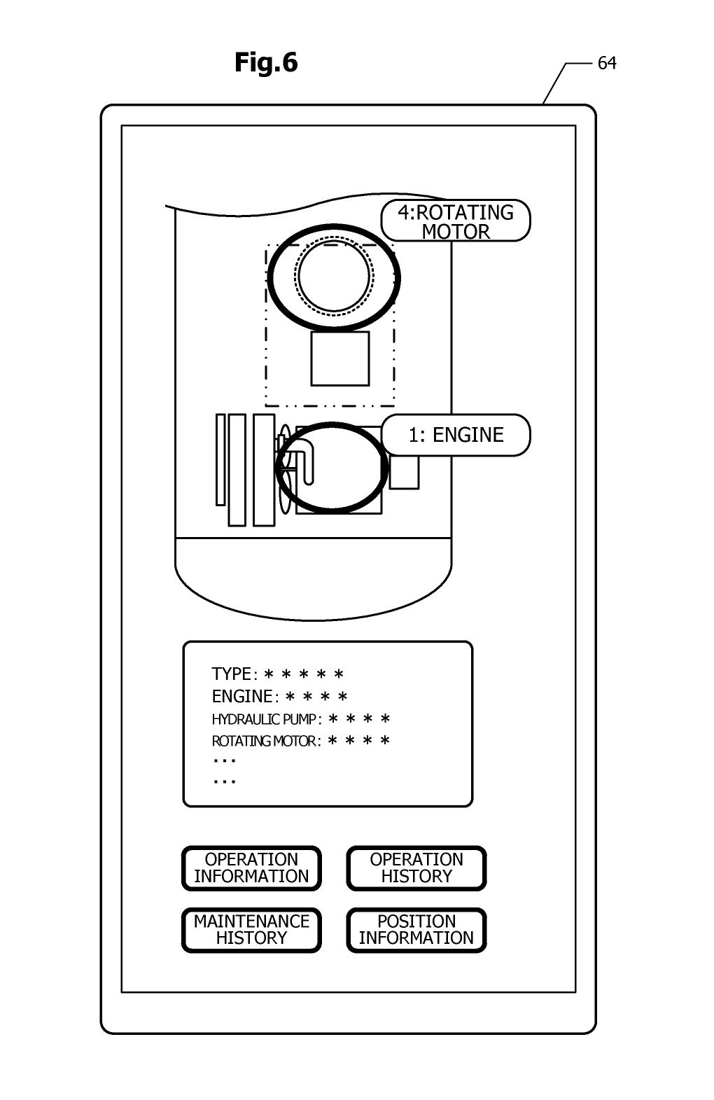

FIG. 6 shows an example of the image displayed on the display device 64. The machine controller 61 displays the image of the machine body of the shovel on the display device 64 such that a portion including the suspected component is distinguished from other portions. For example, the portion including the suspected component is displayed so as to be surrounded by a thick closed curve. When the failure estimation information shown in FIG. 5 is received, the positions of the engine and the rotating motor are surrounded by a thick closed curve.

In addition, basic information about, for example, the type of shovel, an engine, a hydraulic pump, and a rotating motor is displayed on the display device 64. Furthermore, a plurality of operation buttons for displaying other information, for example, “operation information”, “operation history”, “maintenance history”, and “position information” buttons are displayed. When the operation information button is selected, this week's operation information is displayed on the display device 64. When the operation history button is selected, the past operation information before this week is displayed. When the maintenance history button is selected, the past maintenance history is displayed. When the position information button is selected, a map is displayed and a symbol, for example, an arrow indicating the current position in the map is displayed.

When the portion including the suspected component is designated by the pointing device 65, the name and priority of the portion are displayed. For example, when the position of the engine is designated by the pointing device 65, the highest priority, which is “1” in this case, associated with the suspected component included in the portion and the name of the portion, “engine”, are displayed. When the position of the rotating motor is designated by the pointing device 65, the highest priority, which is “4” in this case, associated with the suspected component included in the portion and the name of the portion, “rotating motor”, are displayed. The color of the thick closed curve may vary depending on priority. Here, the suspected portion is highlighted by the thick closed curve. Instead, the suspected portion may be highlighted by other forms which enable the operator or a maintenance person to visibly identify the suspected portion with ease. For example, a dotted or dashed closed curve may be used or the suspected portion may be displayed so as to blink.

When the portion including the suspected component is designated by the pointing device 65, the machine controller 61 displays the enlarged image of the designated portion on the display device 64.

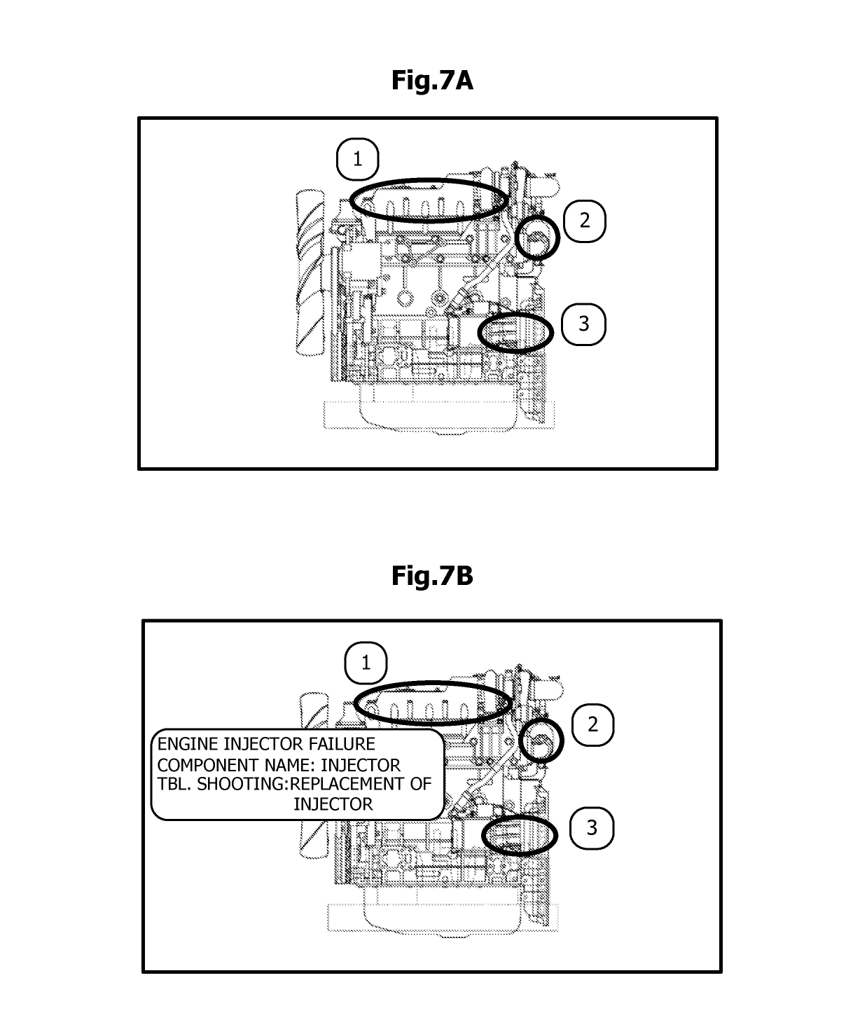

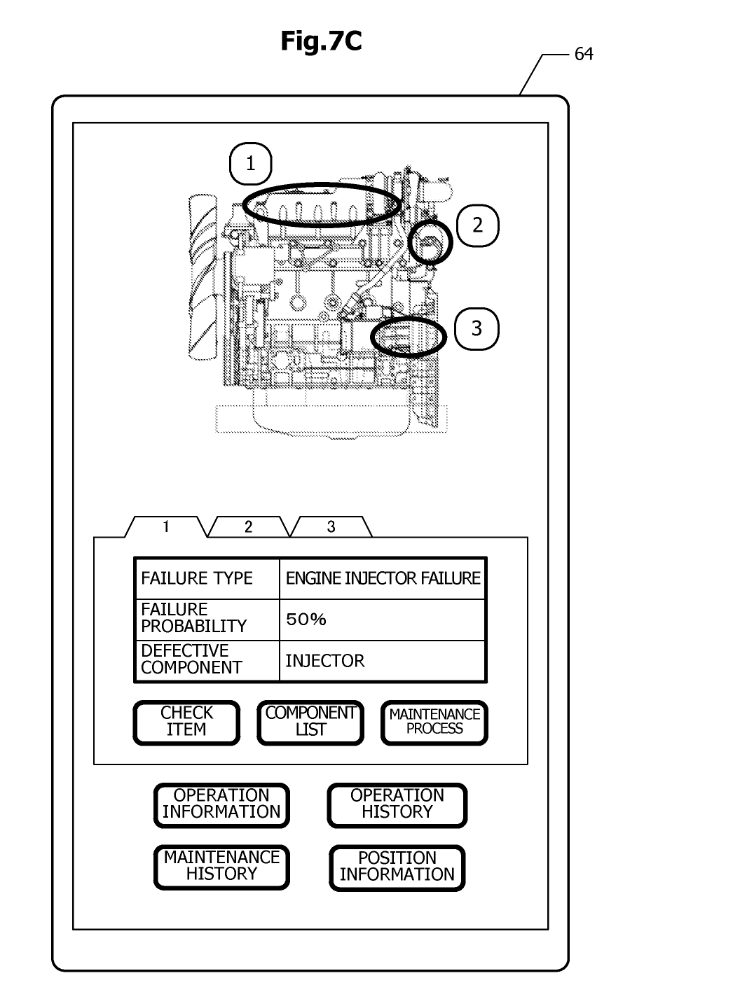

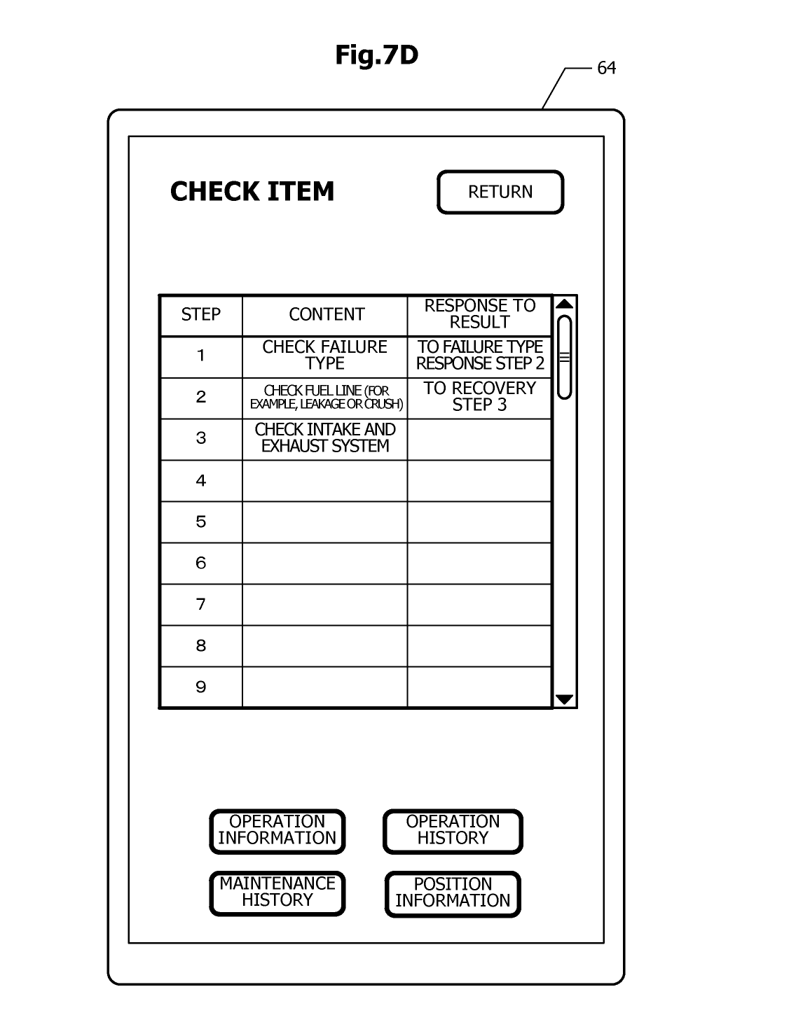

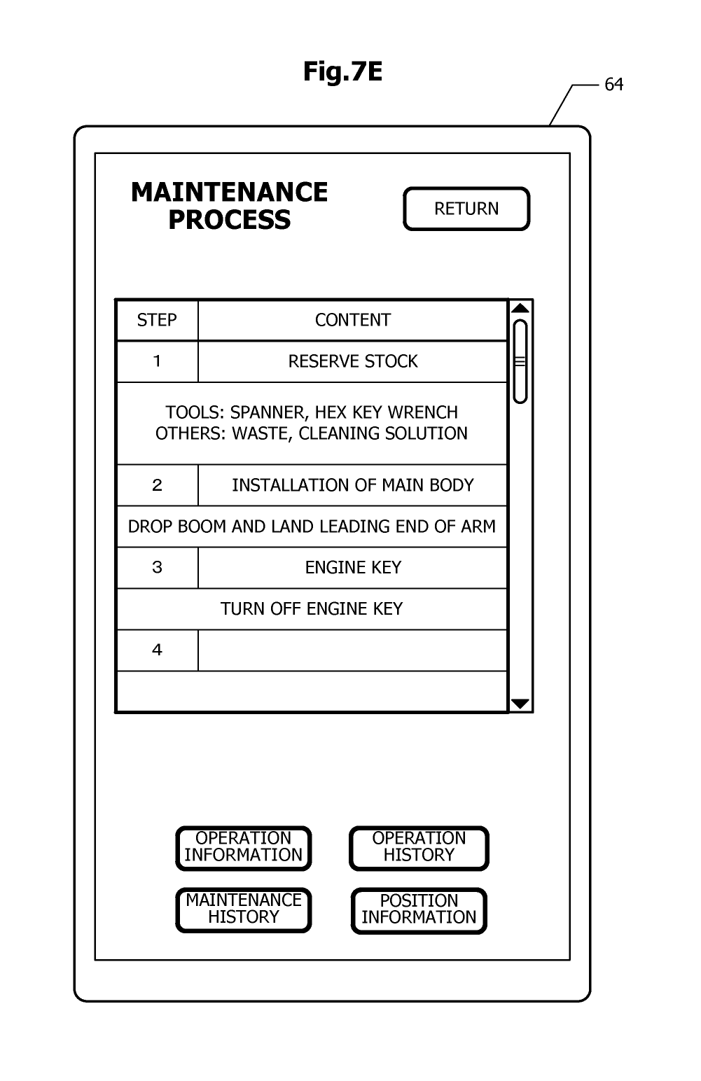

FIG. 7A shows an example of the enlarged image displayed when the portion “engine” is designated by the pointing device 65. The portion including the suspected component is displayed such that the suspected component can be distinguished from other components and priority associated with the suspected component can be recognized. In FIG. 7A, the suspected component is surrounded by a thick closed curve such that the suspected component is distinguished from other components. A number in a circle which is displayed in the vicinity of the suspected component indicates priority. A dotted or dashed closed curve may be used instead of the thick closed curve or the suspected component may be displayed so as to blink.

When the suspected component is designated by the pointing device 65, the machine controller 61 displays a failure name, a component name, and trouble shooting which correspond to the designated suspected component. FIG. 7B shows an example displayed when a component “injector” is designated. For example, “engine injector failure” is displayed as the failure name, “injector” is displayed as the component name, and “injector replacement” is displayed as the trouble shooting.

Since the portion and component which are estimated to be defective are displayed as images, the maintenance person can specify a defective part with ease. Even when there are a plurality of parts which are estimated to be defective, it is easy to narrow down the defective part since priority is associated with the defective component. It is possible to find an appropriate repair method in a short time on the basis of information, such as trouble shooting, displayed on the display device 64.

When there is one portion including the suspected component, the enlarged image of the portion shown in FIG. 7A may be displayed without displaying the image of the machine body including the plurality of portions shown in FIG. 6. When one suspected component is included in a portion, the suspected component may be displayed in FIG. 7A. When it is difficult to grasp the portion from the display of only the image of the suspected component, the entire image of the portion may be displayed such that the suspected component can be specified.

Similarly to FIG. 6, a plurality of operation buttons for displaying other information may be displayed, which is not shown in FIGS. 7A and 7B.

FIG. 7C shows another example of the display of the suspected portion. In the example shown in FIG. 7C, failure information is displayed in addition to the image of the engine. Similarly to the example shown in FIG. 6, a plurality of operation buttons for displaying other information are displayed.

The failure information is displayed in a tab form in such a manner that the failure information for each priority is put into one tab. A failure type, failure probability, and a defective component are displayed in a display area corresponding to one tab and a check item button, a component list button, and a maintenance process button are also displayed in the display area. The term “failure probability” means the probability of the failure of the displayed failure type occurring in the shovel to be evaluated. When a tab different from the currently displayed tab is selected, failure information with another priority corresponding to the selected tab is displayed.

FIG. 7D shows an example of the image displayed when the check item button (FIG. 7C) is selected. As check items, a plurality of contents to be checked and response to the check result are displayed. The operator performs a check operation according to the check items to easily specify a defective component. Similarly to FIG. 6, a plurality of operation buttons for displaying other information are also displayed. In addition, a “return” button is displayed.

FIG. 7E shows an example of the image displayed when the maintenance process button (FIG. 7C) is selected. A reserve stock required for maintenance and the procedure of an operation are displayed in time series. The operator can easily perform maintenance according to the displayed maintenance process. Similarly to FIG. 6, a plurality of operation buttons for displaying other information are also displayed. In addition, a “return” button is displayed.

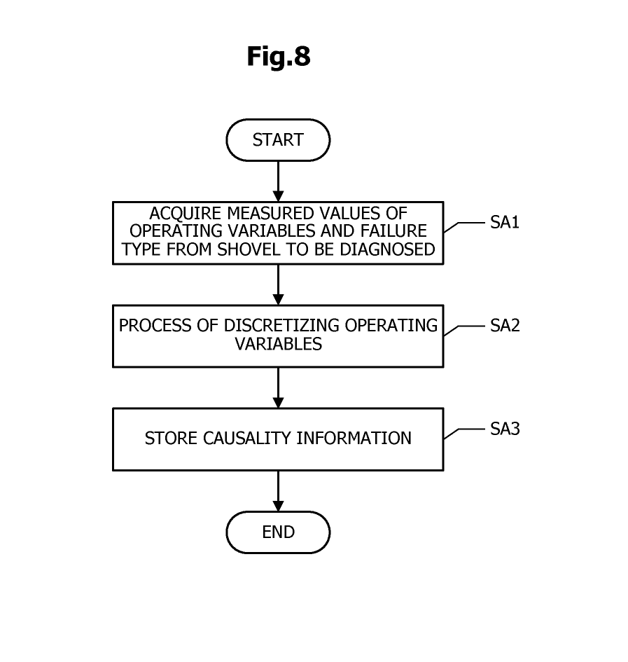

Next, the process of estimating the failure type will be described with reference to FIGS. 8 to 14.

FIG. 8 is a flowchart illustrating a process of creating causality information for failure diagnosis and storing the causality information. In Step SA1, the management device 70 acquires the measured values of the operating variables and the failure type which occurs during the period when the measured values are collected from the shovel 60 to be evaluated.

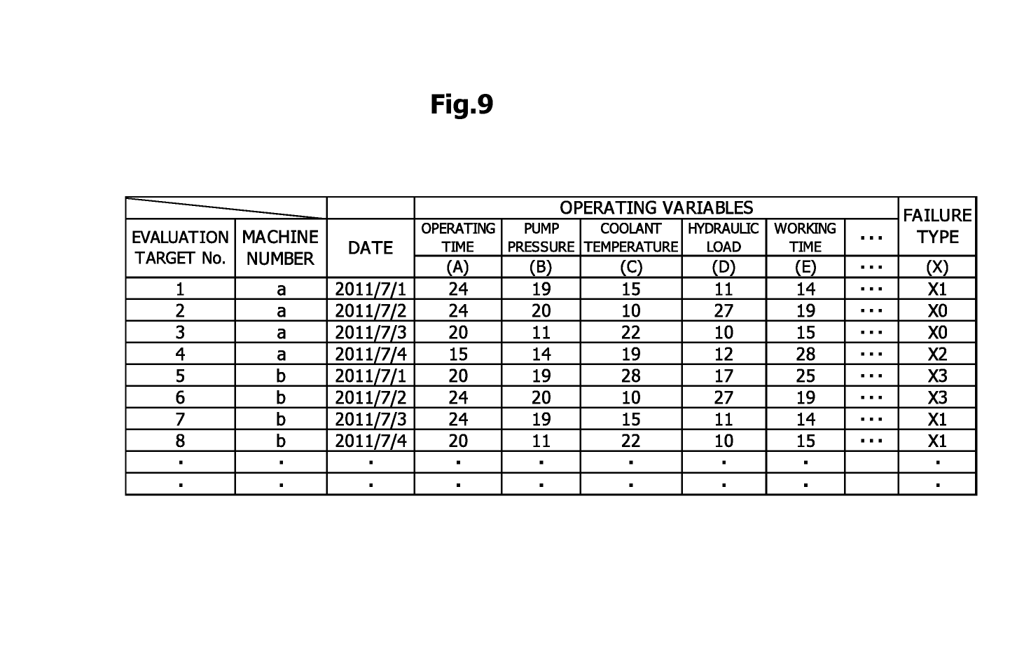

FIG. 9 shows an example of the measured values of the operating variables and the failure type which are acquired in Step SA1. The acquisition of the measured values of the operating variables and the failure type is performed for each machine number of the shovel and each constant collection period. The collection period is set to, for example, a day. An information group which is collected from the machine number of one shovel for one collection period forms one evaluation target.

In FIG. 9, for example, information about evaluation target No. 1 is acquired from a shovel with machine number “a” on Jul. 1, 2011, an operating time A is 24, a pump pressure B is 19, a coolant temperature C is 15, a hydraulic load D is 11, and a working time E is 14. The “operating time” means the time from the pressure of a start switch of the shovel to the pressure of a stop switch, that is, the time for which the shovel is operating. The “working time” means the time for which the operator operates the shovel. The failure type X of the evaluation target No. 1 is X1. This means that a failure of the failure type X1 occurred in the shovel with machine number “a” on Jul. 1, 2011. A failure type X0 shown in FIG. 9 means that no failure occurs.

Then, in Step SA2 (FIG. 8), an operating variable discretization process is performed to replace each operating variable with a finite discrete event.

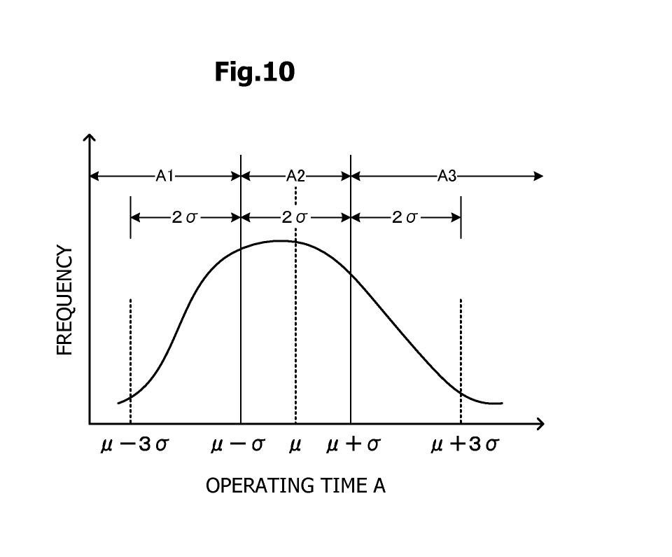

A method of replacing the operating time A with a finite discrete event will be described with reference to FIG. 10. In addition, other operating variables can be similarly replaced with finite discrete events.

FIG. 10 shows an example of a histogram of the operating time A. In FIG. 10, the horizontal axis indicates the operating time A and the vertical axis indicates the number (frequency) of evaluation targets. The average of the operating time A is represented as μ and a standard deviation is represented as σ. The range from μ−3σ to μ+3σ is divided into three equal parts. That is, the horizontal axis is divided into three regions, that is, a region from μ−3σ to μ−σ, a region from μ−σ to μ+σ, and a region from μ+σ to μ+3σ. A section in which the operating time A is equal to or less than μ−σ is represented as A1, a section in which the operating time A is from μ−σ to μ+σ is represented as A2, and a section in which the operating time A is equal to or greater than μ+σ is represented as A3.

For the operating time A, any of an event in which the measured value is in the section A1, an event in which the measured value is in the section A2, and an event in which the measured value is in the section A3 occurs.

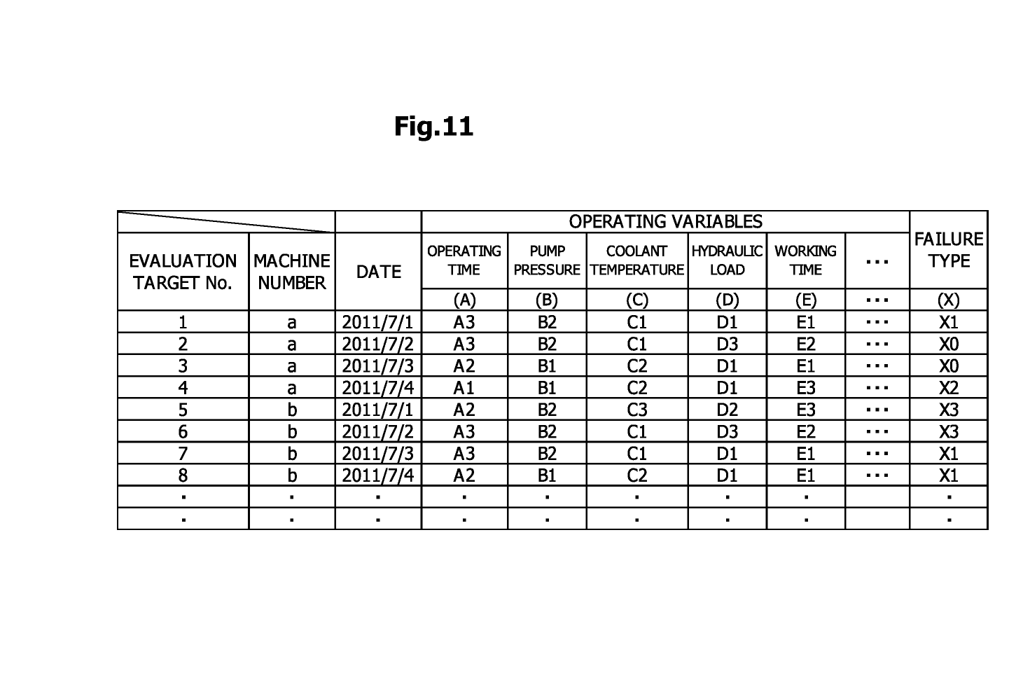

FIG. 11 shows a list of the operating variables after the discretization process and the failure types. The operating time A is represented by section A1, A2, or A3 to which the measured value is belongs. Similarly, other operation information is also replaced with finite discrete events.

Then, in Step SA3 (FIG. 8), causality information is created and is then stored in the storage device 73 (FIG. 3).

The list in which the operating variables A, B, C, . . . of the finite discrete events are associated with the failure type X shown in FIG. 11 is causality information in which the failure type X is a causing event and the operating variable is a result event.

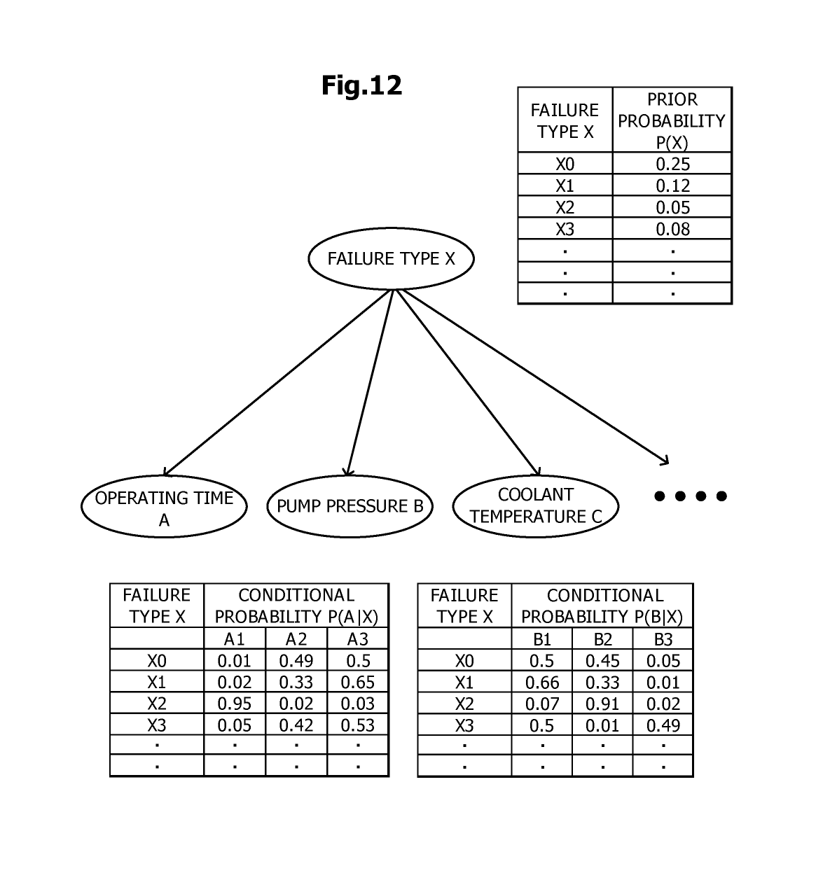

FIG. 12 shows an example of the prior probability and conditional probability of a failure estimation model used in Embodiment 1. It is possible to calculate prior probability P(X) from the causality information shown in FIG. 11, using the failure type X as a causing event and each operating variable as the result event which is assumed to occur due to a cause. In addition, it is possible to calculate conditional probabilities P(A|X), P(B|X), . . . in which an event that each failure case X occurs is a precondition, for each of the operating variables A, B, C, . . . . FIG. 12 shows an example of the calculated prior probability P(X) and the calculated conditional probabilities P(A|X) and P(B|X).

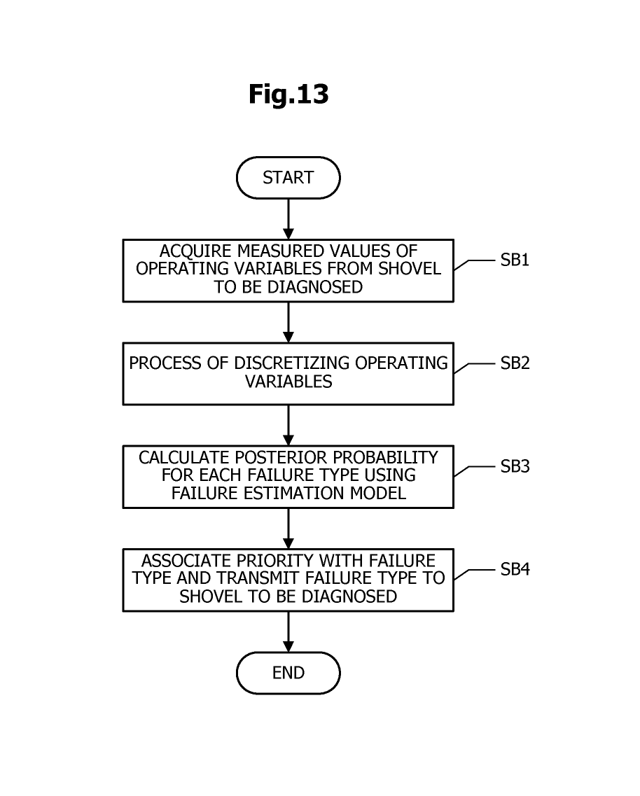

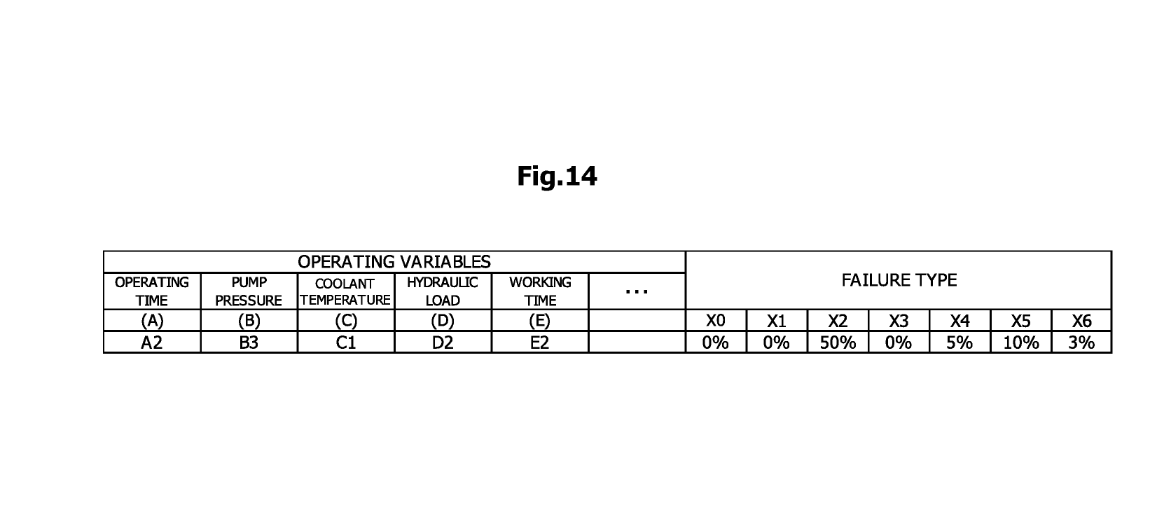

FIG. 13 is a flowchart illustrating a method of estimating the cause of a failure. In Step SB1, the management device 70 acquires the measured values of the operating variables from the shovel to be diagnosed. In Step SB2, a process of discretizing the acquired operating variables is performed. The discretization process is performed on the basis of the same standard as the discretization process performed in Step SA2 of FIG. 8. FIG. 14 shows an example of the operating variables after the discretization process. For example, the discretized value of the operating time A is A2, the discretized value of the pump pressure B is B3, the discretized value of the coolant temperature C is C1, the discretized value of the hydraulic load D is D2, and the discretized value of the working time E is E2.

In Step SB3, posterior probability is calculated for each failure type, using, for example, the prior probability P(X) and the conditional probability P(A|X) obtained from the causality information shown in FIG. 8 (Bayesian estimation is performed).

For example, under the condition that an event that the operating time A is A2 occurs, the posterior probability P(X=X1|A=A2) (hereinafter, referred to as P(X1|A2)) of the failure of the failure type X1 occurring can be calculated by the following expression:

$$P ( X 1 \vert A 2 ) = \frac{P ( A 2 \vert X 1 ) P ( X 1 )}{{\sum }_{X} P ( X ) P ( A 2 \vert X )} . \qquad [ Expression 1 ]$$

Similarly, the posterior probabilities P(X2|A2), P(X3|A2), . . . of the failures of, for example, the failure types X2, X3, etc. occurring can be calculated.

The calculated posterior probabilities P(X1|A2), P(X2|A2), P(X3|A2) . . . are treated as new prior probabilities. Under the condition that an event that the discretized value of the pump pressure B is B3 occurred, the posterior probability P(X1|A2, B3) of the failure of the failure type X1 occurring can be calculated by the following expression:

$$P ( X 1 \vert A 2 , B 3 ) = \frac{P ( B 3 \vert X 1 , A 2 ) P ( X 1 \vert A 2 )}{{\sum }_{X} P ( X \vert A 2 ) P ( B 3 \vert X , A 2 )} . \qquad [ Expression 2 ]$$

It is assumed that the operating time A and the pump pressure B are independent.

P(B3|X1, A2) on the right side of the above-mentioned expression can be calculated from the causality information shown in FIG. 8. Similarly, the posterior probabilities P(X2|A2, B3), P(X3|A2, B3), . . . of the failures of, for example, the failure types X2, X3, etc. occurring can be calculated.

Other operating variables, such as the coolant temperature C, the hydraulic load D, and the working time E, are added as new results and the posterior probability is calculated. Therefore, it is possible to further improve the objectivity of the calculated posterior probability.

FIG. 14 shows an example of the calculated posterior probability. In this example, the probability of the failures of the failure types X2, X4, X5, and X6 occurring are estimated to be 50%, 5%, 10%, and 3%, respectively, in the shovel to be diagnosed. That is, the following expression is established:

P(X2|A2,B3,C1,D2,E2, . . . )=50%

P(X4|A2,B3,C1,D2,E2, . . . )=5%

P(X5|A2,B3,C1,D2,E2, . . . )=10%.

P(X6|A2,B3,C1,D2,E2, . . . )=3% [Expression 3]

In the above-described Embodiment 1, the result event is sequentially added to calculate new posterior probability in stages. However, the posterior probability is not necessarily calculated in stages. The posterior probability of the failure type may be calculated using the causality information shown in FIG. 11. The posterior probability of the failure type may be calculated on the basis of, for example, the prior probability P(X) and the conditional probabilities P(A|X) and P (B|X) of each operating variable shown in FIG. 12, considering all operating variables as the result events.

As described above, Bayesian inference can be performed on the basis of the causality information shown in FIG. 11, using the discretized values of the measured values of the operating variables shown in FIG. 14 as the result events, to calculate the posterior probability of the failure type, which is a causing event. Priority is given to the failure type on the basis of the magnitude relationship between the posterior probabilities of the estimated failure types. In the example shown in FIG. 14, the priority of the failure type X2 is “1”, the priority of the failure type X5 is “2”, the priority of the failure type X4 is “3”, and the priority of the failure type X6 is “4”.

Then, in Step SB4 (FIG. 13), the failure estimation information (FIG. 5) in which priority is associated with the estimated failure type is transmitted to the shovel to be diagnosed. The processing device 72 also displays the failure estimation information as an image on the display device 74 of the management device 70. The image displayed on the display device 74 of the management device 70 is the same as the image displayed on the display device of the shovel 60 shown in FIG. 6 and FIGS. 7A and 7B and the process when a portion or a suspected component is designated by the pointing device is also the same as the process of the machine controller 61 of the shovel. The estimation process of the management device 70 may be performed by the machine controller 61 provided in the shovel. In this case, a device which corresponds to the storage device 73 for storing information required for the estimation process is provided in the shovel. The result of the estimation process is transmitted to the management device 70. The processing device 72 of the management device 70 displays the received result of the estimation process on the display device 74. In this case, for example, a portable information terminal is used as the management device 70.

The estimation result of the past estimation process may be stored as estimation result information in the machine controller 61 of the shovel. When the estimation result information is stored in the machine controller 61, priority can be given to the failure type on the basis of the estimation result information, without performing communication with the management device 70, if necessary, and the failure type can be output. When an operation is performed by the shovel in a remote area in which communication with the management device 70 is not available and a certain failure occurs in the shovel, it is possible to start rapidly repairing the shovel on the basis of the past estimation result information.

### Embodiment 2

Next, Embodiment 2 will be described. Hereinafter, the difference from Embodiment 1 will be described and the description of the same structure as that in Embodiment 1 will be omitted.

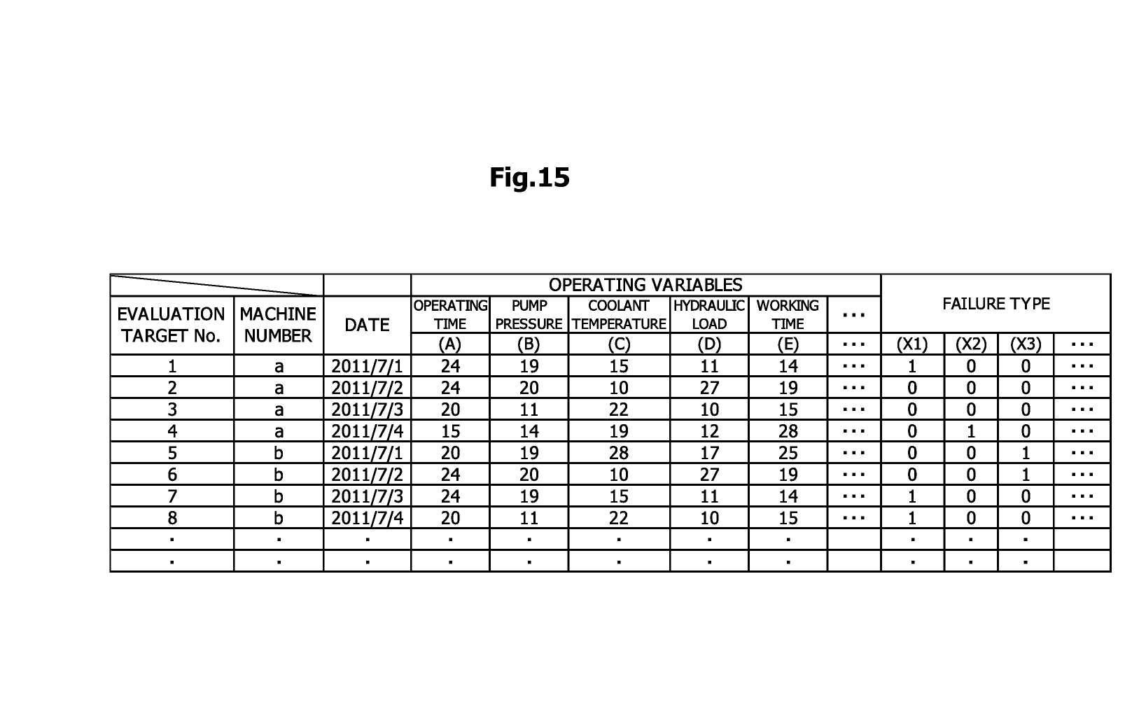

In Embodiment 1, as shown in FIG. 6, any one of the failure types X0, X1, X2, . . . corresponds to the evaluation target. In Embodiment 2, as shown in FIG. 15, information indicating whether each of the failures of the failure types X1, X2, . . . occurs corresponds to the evaluation target. For each failure type, it is assumed that a value when a failure of the failure type occurs is “1” and a value when the failure does not occur is “0”.

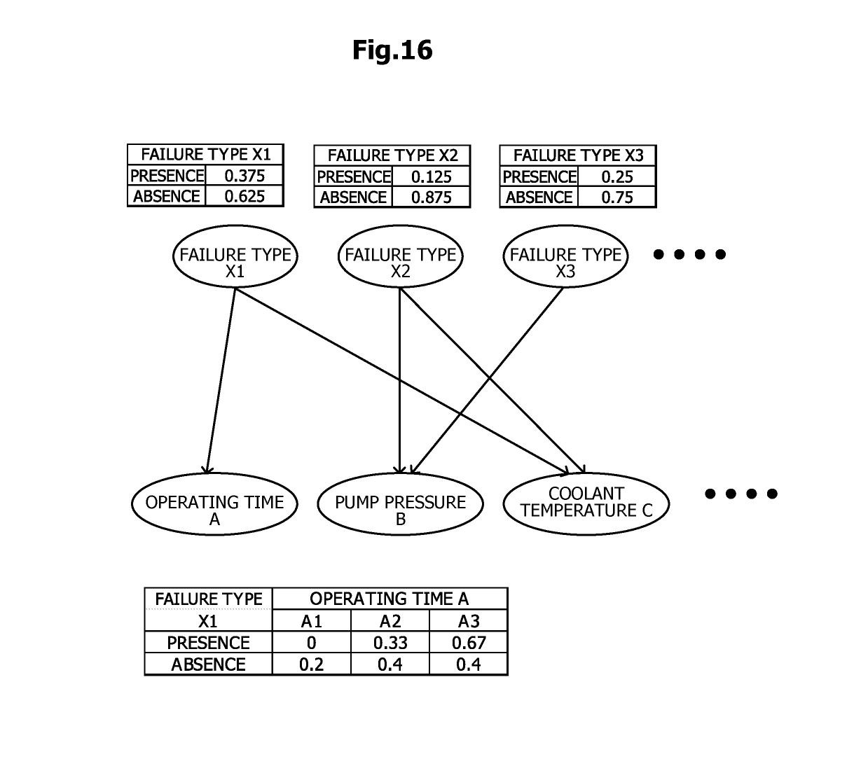

FIG. 16 shows a causal relationship model between a causing event and a result event. For example, a given failure type is associated with an operating variable which is affected by the occurrence of the failure. In FIG. 16, for example, an operating time A and a coolant temperature C are associated with the failure type X1. For example, the prior probabilities P(X1), P(X2), and P(X3) that failures of the failure types X1, X2, and X3 will occur are 0.375, 0.125, and 0.25, respectively. In addition, the prior probabilities P(X1^{C}), P(X2^{C}), and P (X3^{C}) that the failures of the failure types X1, X2, and X3 will not occur are 0.625, 0.875, and 0.75, respectively. Here, “X1^{C}” means an event in which the failure of the failure type X1 does not occur.

A method of calculating posterior probability in Step SB3 (FIG. 13) will be described. For example, under the condition that an event that the operating time is A2 occurred, the posterior probability P(X1|A=A2) (hereinafter, referred to as P(X1|A2)) of the failure of the failure type X1 occurring can be calculated by the following expression:

$$P ( X 1 \vert A 2 ) = \frac{P ( A 2 \vert X 1 ) P ( X 1 )}{P ( X 1 ) P ( A 2 \vert X 1 ) + P ( X {1}^{C} ) P ( A 2 \vert X {1}^{C } )} . \qquad [ Expression 4 ]$$

The calculated posterior probability P(X1|A2) is treated as new prior probability. Under the condition that an event that the discretized value of the coolant temperature C is C1 (see FIG. 14) occurred, the posterior probability P(X1|A2, C1) of the failure of the failure type X1 occurring can be calculated by the following expression:

$$P ( X 1 \vert A 2 , C 1 ) = \frac{P ( C 1 \vert X 1 , A 2 ) P ( X 1 \vert A 2 )}{\begin{matrix}P ( X 1 \vert A 2 ) P ( C 1 \vert X 1 , A 2 ) + \\ P ( X {1}^{C} \vert A 2 ) P ( C 1 \vert X {1}^{C} , A 2 )\end{matrix}} . \qquad [ Expression 5 ]$$

When there are other operating variables associated with the failure type X1, the calculated posterior probability P (X1|A2, C1) is treated as prior probability and other operating variables associated with the failure type X1 are added as a new result to calculate posterior probability. In this way, it is possible to further increase the objectivity of the calculated posterior probability.

Similarly, it is possible to calculate the posterior probabilities of the failures of, for example, the failure types X2 and X3 occurring. The same table as that in Embodiment 1 shown in FIG. 14 is obtained based on the calculation result of the posterior probability.

The embodiments of the invention have been described above, but the invention is not limited thereto. For example, it will be understood by those skilled in the art that various changes, improvements, and combinations can be made.

### REFERENCE SIGNS LIST

20: BASE CARRIER (BASE)
21: ROTATING MECHANISM
23: UPPER ROTATING BODY
24: BOOM
25: BOOM CYLINDER
26: ARM
27: ARM CYLINDER
28: BUCKET
29: BUCKET CYLINDER
30: CABIN
31: ENGINE
32: TORQUE CONVERTER
34: MAIN PUMP
36: HIGH-PRESSURE HYDRAULIC LINE
37: CONTROL VALVE
38A, 38B: HYDRAULIC MOTOR
40: CONTROL DEVICE
45: ROTATING HYDRAULIC MOTOR
50: PILOT PUMP
51: PILOT LINE
52: OPERATION DEVICE
53, 54: HYDRAULIC LINE
55: PRESSURE SENSOR
60: SHOVEL
61: MACHINE CONTROLLER
62: COMMUNICATION DEVICE
63: IN-MACHINE GPS DEVICE
64: DISPLAY DEVICE
65: POINTING DEVICE
70: MANAGEMENT DEVICE (MANAGEMENT CENTER)
71: COMMUNICATION DEVICE
72: PROCESSING DEVICE
73: STORAGE DEVICE
74: DISPLAY DEVICE
75: POINTING DEVICE
80: COMMUNICATION LINE

1. A shovel comprising:
a display device; and
a machine controller that controls the display device,
wherein the machine controller displays a suspected component which is estimated to be defective on the display device such that priority associated with the suspected component can be recognized, on the basis of failure estimation information including the suspected component and the priority associated with the suspected component.

2. The shovel according to claim 1,
wherein a plurality of portions, each including a plurality of components, are defined,
the failure estimation information includes information indicating trouble shooting for each suspected component, and
the machine controller displays the portion including the suspected component on the display device such that the suspected component can be distinguished from other components.

3. The shovel according to claim 1, further comprising:
a pointing device that is adapted to designate a position on a display screen of the display device,
wherein the machine controller displays trouble shooting corresponding to the suspected component when the suspected component is designated by the pointing device.

4. The shovel according to claim 3,
wherein a plurality of portions, each including a plurality of components, are defined,
the machine controller displays a machine body including the plurality of portions on the display device on the basis of the failure estimation information such that the portion including the suspected component can be distinguished from other portions, and
when the portion including the suspected component is designated by the pointing device, the machine controller displays the designated portion on the display device such that the suspected component can be distinguished from other components and the priority associated with the suspected component can be recognized.

5. A shovel management device comprising:
a display device; and
a processing device that controls the display device,
wherein the processing device displays a suspected component which is estimated to be defective in a shovel on the display device such that priority associated with the suspected component can be recognized, on the basis of failure estimation information including the suspected component and the priority associated with the suspected component.

6. The shovel management device according to claim 5, further comprising:
a storage device that stores, as causality information, measured values of a plurality of operating variables related to operation information which is acquired from the shovel with respect to each evaluation target which is to be evaluated as a unit and a failure type for specifying a failure which occurs in the evaluation target so as to be associated with each other,
wherein the processing device calculates the suspected component and the priority on the basis of the measured values of the operating variables acquired from the shovel to be diagnosed, and the causality information stored in the storage device.

7. The shovel management device according to claim 6,
wherein the processing device calculates posterior probability of the failure type on the basis of the measured values of the operating variables acquired from the shovel to be diagnosed and the causality information stored in the storage device and calculates the suspected component and the priority based on the calculated posterior probability.

8. The shovel management device according to claim 5,
wherein the processing device acquires, from the shovel, measured values of a plurality of operating variables related to operation information about the shovel and a failure type for specifying a failure which occurs in an evaluation target with respect to each evaluation target which is to be evaluated as a unit,
the processing device stores, as causality information, the plurality of operating variables and the plurality of failure types so as to be associated with each other with respect to the acquired evaluation targets, and
the processing device calculates posterior probability of the failure type on the basis of the causality information, using an event that the operating variables are the measured values acquired from the shovel to be diagnosed as a result.

9. The shovel management device according to claim 7,
wherein the processing device calculates the posterior probability of the failure type on the basis of the causality information, using an event that the operating variables are the measured values acquired from the shovel to be diagnosed as a result.

10. The shovel management device according to claim 8,
wherein the processing device calculates conditional probability with respect to each operating variable using an event that each failure type occurs as a precondition and calculates the posterior probability on the basis of the calculated conditional probability.

11. The shovel management device according to claim 8,
wherein the processing device discretizes the measured value of each of the plurality of operating variables and treats each of the operating variables as a finite discrete event.

12. The shovel management device according to claim 5, further comprising:
a communication device configured to receive the suspected component and the failure estimation information from the shovel.

13. The shovel management device according to claim 12,
wherein the failure estimation information includes information indicating trouble shooting for each suspected component, and
the processing device displays the suspected component and the information indicating the trouble shooting on the display device.

14. The shovel management device according to claim 12,
wherein a plurality of portions, each including a plurality of components, are defined in the shovel, and
the processing device displays the portion including the suspected component on the display device such that the portion including the suspected component can be distinguished from other portions.

15. A shovel management method comprising:
acquiring failure estimation information including a suspected component which is estimated to be defective among components of a shovel to be diagnosed and priority which is associated with the suspected component; and
displaying the suspected component on a display device such that the priority associated with the suspected component which is included in the failure estimation information can be recognized.

16. The shovel management method according to claim 15, further comprising:
before acquiring the failure estimation information,
acquiring, from the shovel, measured values of a plurality of operating variables related to operation information about the shovel;
calculating posterior probability of a failure type for specifying a failure which occurs in an evaluation target which is to be evaluated as a unit, on the basis of causality information in which the measured values of the operating variables acquired from the shovel with respect to each evaluation target and the failure type are associated with each other, using an event that the operating variables are the measured values acquired from the shovel to be diagnosed as a result; and
calculating the priority associated with the suspected component on the basis of the calculated posterior probability.
